(19) United States
(12) Patent Application Publication
(10) Pub. No.: US 2014/0157934 A1
(43) Pub. Date: Jun. 12, 2014

(54) Shifting apparatus for vehicle with DCT and control method thereof

(71) Applicant: HYUNDAI MOTOR COMPANY, Seoul (KR)

(72) Inventors: Young Min Yoon, Seoul (KR); Seong Hwan Cheong, Seoul (KR); Jong Ho Hong, Seoul (KR)

(73) Assignee: HYUNDAI MOTOR COMPANY, SEOUL (KR)

(21) Appl. No.: 13/986,101

(22) Filed: Mar. 18, 2013

(30) Foreign Application Priority Data
Dec. 6, 2012 (KR) 10-2012-0141410

(51) Int. Cl. F16H 59/02

(52) U.S. Cl. CPC F16H 59/0204
USPC 74/473.18

(57) ABSTRACT

An shifting apparatus includes a shift gate pattern allowing manual shifting as well as a shift gate pattern allowing automatic shifting and to implement a manual shift gate pattern substantially at the same level as a vehicle with an MT in the vehicle with a DCT such that a driver can enjoy more dynamic and interesting shifting with maintaining the advantages of convenient automatic shifting, thereby improving the commercial value of the vehicle, and a method thereof.

### CROSS-REFERENCE TO RELATED APPLICATION

This application claims, under 35 U.S.C. §119(a), the benefit of priority to Korean Patent Application No. 10-2012-0141410 filed on Dec. 6, 2012, the entire contents of which are incorporated herein by reference.

### TECHNICAL FIELD

The present disclosure relates to a shifting apparatus for a vehicle and a method thereof, and more particularly, to a mechanism for a user to operate a transmission in a vehicle with a Double Clutch Transmission (DCT) and a technology relating to the mechanism.

### BACKGROUND

FIG. 1 shows a shift gate pattern of a vehicle with DCT of the related art, where a driver shifts a gear by moving a shift lever to the shift gate pattern and a portion of the shift gate pattern has a manual mode to allow the driver to determine the gear to shift into during traveling, so that the driver can select gears appropriate for the traveling conditions on a road and the driver can experience a dynamic drive.

However, the manual mode gate pattern of the shift gate pattern of the related art is simply able to only increase/decrease the gears one by one by operating the shift lever, so that it has a large difference in feeling of manual operation that operates a shift lever, using a shift gate pattern of a vehicle with a Manual Transmission (MT) of the related art shown in FIG. 2.

The description provided above as a related art of the present disclosure is just for helping understanding the background of the present disclosure and should not be construed as being included in the related art known by those skilled in the art.

### SUMMARY OF THE DISCLOSURE

A need exists for providing a shifting apparatus for a vehicle with a DCT which can implement a shift gate pattern allowing manual shifting as well as a shift gate pattern allowing automatic shifting and can implement a manual shift gate pattern substantially at the same level as a vehicle with an MT such that a driver can enjoy more dynamic and interesting experience in shifting , keeping the advantages of convenient automatic shifting intact. This enhances the commercial value of the vehicle.

A shifting apparatus of a vehicle with a DCT includes: a shift gate pattern including an automatic mode gate 1 with a series of P-, R-, N-, and D-ranges in a straight line and a manual mode gate 3 connected with a neutral line 3-1 at the N-range perpendicular to the automatic mode gate 1 and overlapping at least a portion of the automatic gate mode 1; and an automatic switch 11 that can check switching from the manual mode gate 3 to the automatic mode gate 1 by movement of a shift lever 9 moving in the shift gate pattern.

A method of controlling a shifting apparatus of a vehicle with a DCT according to the present disclosure determines that it is the automatic mode, when the engine starts with the shift lever at the P- or the N-range of the automatic mode gate, and that it is the manual mode, when the engine starts with the shift level at the neutral line of the manual mode gate.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a diagram showing a shift gate pattern of a vehicle with a DCT according to the related art;

FIG. 2 is a diagram showing a shift gate pattern of a vehicle with an MT according to the related art;

FIG. 3. is a diagram showing a shift gate pattern of a shifting apparatus of a vehicle according to an exemplary embodiment of the present disclosure;

FIG. 4 is a diagram showing a structure for sensing a shift lever of the shift gate pattern shown in FIG. 3;

FIG. 5 is a diagram showing the sensing structure of FIG. 4, using a circuit concept diagram; and

FIG. 6 is a diagram illustrating a method of controlling a shifting apparatus of a vehicle with a DCT according to the present disclsoure.

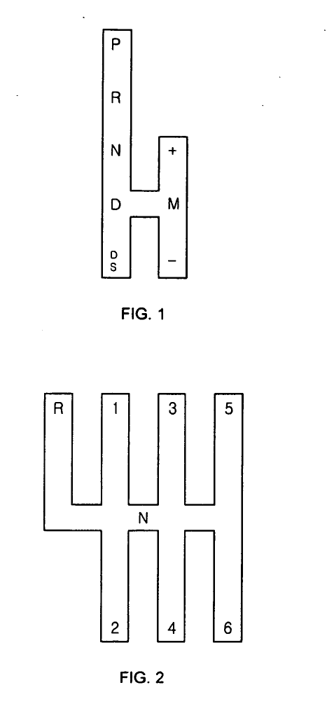

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

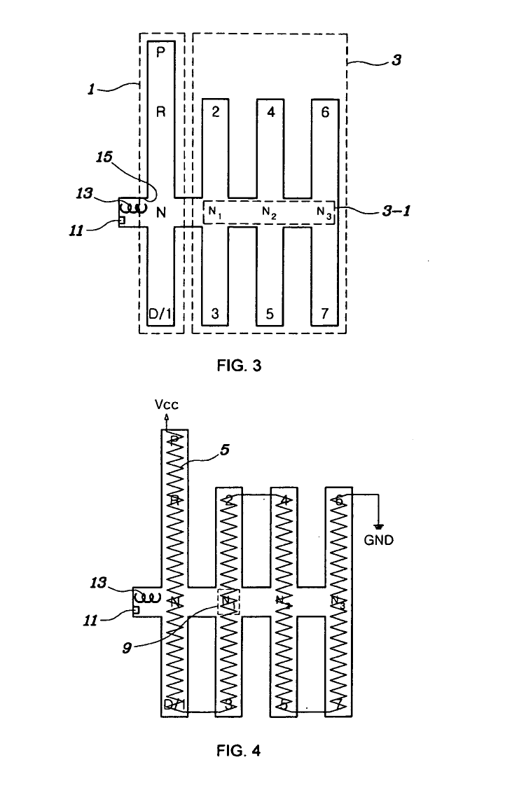

Referring to FIG. 3, a shifting apparatus of a vehicle with a DCT according to an exemplary embodiment of the present disclosure includes a shift gate pattern composed of an automatic mode gate 1 with a series of P-, R-, N-, and D-ranges in a straight line and a manual mode gate 3 connected with a neutral line 3-1 at the N-range perpendicular to the automatic mode gate 1 and overlapping at least a portion of the automatic gate mode 1. The shifting apparatus further includes an automatic switch 11 that allows a driver to switch from the manual mode gate 3 to the automatic mode gate 1 by movement of a shift lever 9 moving in the shift gate pattern.

That is, according to an exemplary embodiment of the present disclosure, the automatic mode gate 1 and the manual mode gate 3 are connected, and particularly, the neutral line 3-1 of the manual mode gate 3 is connected to the N-range of the automatic mode gate 1 to partially overlap, so that switching between the automatic mode gate 1 and the manual mode gate 3 can be performed in the neutral status. Thus, a driver can select shift ranges substantially in the same method as the manual transmission of the related art, after moving the shift lever 9 to the neutral line 3-1 through the N-range while driving in the automatic mode gate 1. The driver can experience dynamic and interesting shifting because the driver still have the same feeing of operating and shifting as the related art

The automatic switch 11 is connected to the automatic mode gate 1 to which the neutral line 3-1 of the manual mode gate 3 is connected, in the automatic mode gate 1, such that the automatic switch 11 can sense the maximum movement of the shift lever 9 to the automatic mode gate 1 from the neutral line 3-1.

That is, the automatic switch 11 is preferably able to return the shift lever 9 to an original position by means of a return spring 13 after the operation of the shift lever 9, as shown in the figure, and, for example, have the same configuration as a push switch, so that the automatic switch 11 is instantaneously turned on and then turned off by the shift lever 9, a controller receives the turning-off as intention of switching to an automatic mode from a driver.

Obviously, the return spring 13 may be separately provided, as shown in the FIGS. 3 and 4, but it may be disposed in the automatic switch 11. Further, as shown in the FIGS. 3 and 4, the automatic switch 11 and the return spring 13 may be disposed in a mount groove 15.

The manual mode gate 3 has the neutral line 3-1 that is disposed perpendicular to the automatic gate mode 1 in a straight line, and a plurality of shift rages arranged respectively in a plurality of straight passages that are connected to both sides along the neutral line 3-1. This configuration is substantially the same configuration as those of the shift gate patterns of manual transmissions.

Further, according to an exemplary embodiment of the present disclosure, the manual mode gate 3 overlaps with the R-, N-, and D-ranges of the automatic mode gate 1 and the ranges are set as R-, N-, and 1-ranges in the manual mode gate 3. That is, the R-, N-, and D-ranges of the automatic mode gate 1 are set to overlap the R-, N-, and 1-ranges of the manual mode gate 3.

In order to accurately find out the position of the shift lever 9 moving in the shift gate pattern described above, an exemplary embodiment of the present disclosure, as shown in FIG. 4, employes variable resistors 5 of which resistances changes with the position of the shift lever 9, and which are disposed along the path of the shift lever 9 moving throughout the automatic mode gate 1 and the manual gate mode 3 of the shift gate pattern. The embodiment further employs a controller 7 that determines the position of the shift lever on the basis of the voltage outputted from the variable resistors 5 depending upon the position of the shift lever 9, so that the position of the shift lever 9 moving in the shift gate pattern is sensed.

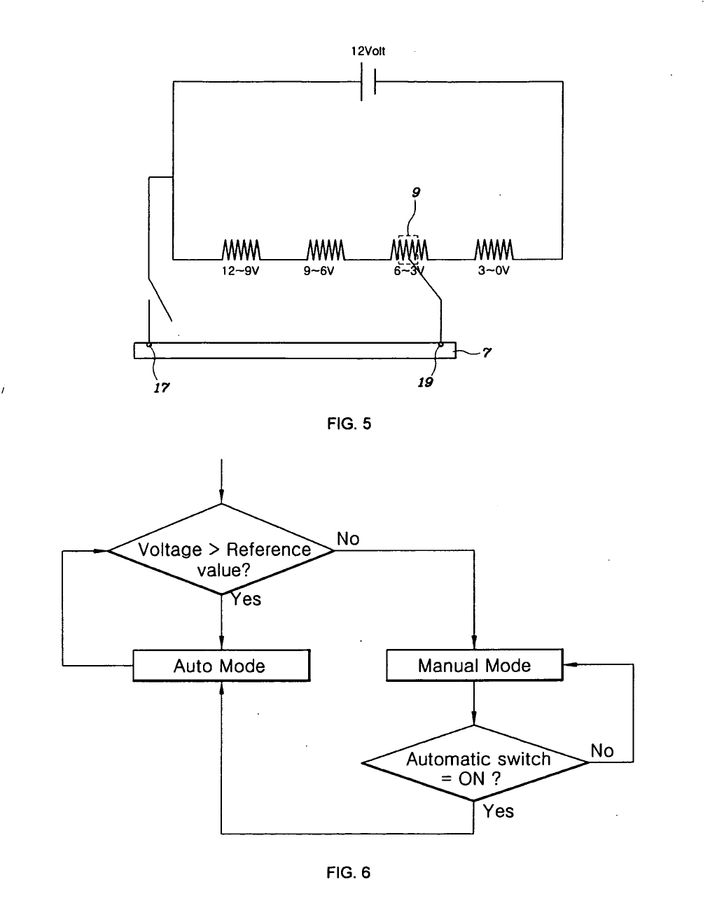

While a separate controller may be provided as the controller 7, a TCU (Transmission Control Unit) controlling the transmission may serve as a controller, and as shown in FIG. 5, it is preferable to have one second input port 19 receiving analog signals from the variable resistors and one first input port 17 receiving digital signals from the automatic switch 11.

In the present exemplary embodiment, in the straight passages, the shift ranges of the automatic mode gate 1 and the manual mode gate 3 are arranged in straight parallel with each other, and the variable resistors 5 include resistors arranged continuously in a zigzag pattern along the automatic mode gate 1 and the straight passages.

The FIG. 5 illustrates the variable resistors 5 of the shift gate pattern, and the controller can obtain the present selected shift range of gear from the voltage value outputted by the resistors 5 of which resistance changes depending upon the position of the shift lever 9.

Therefore, it is possible to determine whether the present mode is the automatic mode or a manual mode depending on whether the voltage outputted from the variable resistors 5 in accordance with the position of the shift lever 9 is a predetermined reference value or more than or less than the reference value. For example, it is possible to determine that 12V˜9V correspond to the P-, R-, N-, and D-ranges of the automatic mode gate 1 or the 1-, N-, and R-ranges of the manual mode gate 3, 9V-6V correspond to the 2-, N-, and 3-ranges of the manual mode gate 3, 6V˜3V correspond to the 4-, N-, and 5-ranges, and 3˜-0V correspond to the 6-, N-, and 7-ranges. In this example, the reference value is 9V from which accurate determination is possible, except for the overlapping portions.

In a method of controlling the shifting apparatus described above, it is determined that it is the automatic mode, when the engine starts with the shift lever 9 at the P- or the N-range of the automatic mode gate 1, and that it is the manual mode, when the engine starts with the shift level 9 at the neutral line 3-1 of the manual mode gate 3.

As shown in FIG. 6, it is determined that the present mode is the automatic mode or the manual mode on the basis of whether the voltages outputted from the variable resistors 5 depending upon the position of the shift lever 9 is the predetermined reference value or more than or less than the reference value. The mode switches from the manual mode to the automatic mode, when the automatic switch 11 is turned on by the shift lever 9.

That is, it is determined whether the present mode is the automatic mode or the manual mode on the basis of the voltage values outputted from the variable resistors depending upon the position of the shift lever 9 while the automatic switch 11 does not operate. But, the mode is switched to the automatic mode, when the automatic switch 11 is turned on by a driver's operation of the shift lever 9.

Further, when the shift lever 9 is positioned at the overlapping portions between the automatic mode gate 1 and the manual mode gate 3, it is determined that the automatic mode gate 1 have been selected in starting of control, and it is determined that it is a portion of the manual mode gate 3, when the shift lever 9 has moved to the overlapping portion from the manual mode gate 3.

That is, when the shift lever 9 is at the overlapping portions at start of controlling such as starting the engine of a vehicle, it is determined that the automatic mode gate 1 has been selected and corresponding control is performed, but when the shift lever 9 moves to the overlapping portions through the neutral line 3-1 from other shift ranges of the manual mode gate 3 without operating the automatic switch 11, it is determined that one of the R-, N-, and 1-ranges, which are portions of the manual mode gate 3, has been selected.

On the other hand, when the shift lever 9 is entering the manual mode gate 3 from the automatic mode gate 1, the shift lever 9 enters into manual mode gate 3 with keeping the gear of the shift range engaged and the clutch, which is connected to the shift range, disengaged.

When a shift range is selected by operating the shift lever 9 in the manual mode, the gear of the selected shift range is engaged and the clutch is engaged with the engaged shift range, and when the shift lever 9 moves to the neutral line 3-1 from the selected shift range of the manual mode, the clutch is disengaged to be ready for selection of another shift range.

According to the present disclosure, it is possible to implement a shift gate pattern allowing manual shifting as well as a shift gate pattern allowing automatic shifting and to implement a manual shift gate pattern substantially at the same level as a vehicle with an MT such that a driver can enjoy more dynamic and interesting shifting with maintaining the advantages of convenient automatic shifting intact, thereby improving the commercial value of the vehicle, and a method thereof.

The disclosure has been described in detail with reference to preferred embodiments thereof. However, it will be appreciated by those skilled in the art that changes may be made in these embodiments without departing from the principles and spirit of the inventive concept, the scope of which is defined in the appended claims and their equivalents.

What is claimed is:

1. A shifting apparatus of a vehicle with a Double Clutch Transmission (DCT), comprising:
a shift gate pattern including an automatic mode gate with a series of P-, R-, N-, and D-ranges in a straight line and a manual mode gate connected with a neutral line at the N-range perpendicular to the automatic mode gate and overlapping at least a portion of the automatic gate mode; and
an automatic switch that checks switching from the manual mode gate to the automatic mode gate by movement of a shift lever moving in the shift gate pattern.

2. The shifting apparatus according to claim 1, wherein the automatic switch is connected to the automatic mode gate to which the neutral line of the manual mode gate is connected, in the automatic mode gate, such that the automatic switch senses the maximum movement of a shift lever to the automatic mode gate from the neutral line.

3. The shifting apparatus according to claim 2, wherein the automatic gate mode is disposed perpendicular to the neutral line in a straight line, has a plurality of shift ranges arranged respectively in a plurality of straight passages perpendicularly connected to both sides of the neutral line, and overlaps with the R-, N-, and D-ranges of the automatic mode gate.

4. The shifting apparatus according to claim 3, further comprising:
variable resistors of which resistances change depending upon the position of the shift lever which are disposed along the path of the shift lever moving throughout the automatic mode gate and the manual gate mode of the shift gate pattern; and
a controller that determines the position of the shift lever on the basis of the voltage outputted from the variable resistors depending upon the position of the shift lever.

5. The shifting apparatus according to claim 4, wherein, in the straight passages, the shift ranges of the automatic mode gate and the manual mode gate are arranged in straight with each other, and the variable resistors include resistors arranged continuously in a zigzag pattern along the automatic mode gate and the straight passages.

6. A method of controlling the shifting apparatus of claim 4, comprising:
determining that it is the automatic mode, when the engine starts with the shift lever at the P- or the N-range of the automatic mode gate; and
determining that it is the manual mode, when the engine starts with the shift level at the neutral line of the manual mode gate.

7. The method according to claim 6; further comprises:
determining that the present mode is the automatic mode or the manual mode on the basis of whether the voltages outputted from the variable resistors depending upon the position of the shift lever is the predetermined reference value or more than or less than the reference value; and
determining that the mode switches to the automatic mode from the manual mode, when the automatic switch is turned on by the shift lever.

8. The method according to claim 7, further comprises:
determining that the automatic mode gate have been selected in starting of control, when the shift lever is at the overlapping portions of the automatic mode gate and the manual mode gate; and
determining that it is a portion of the manual mode gate, when the shift lever has moved to the overlapping portion from the manual mode gate.

9. The method according to claim 6, wherein when the shift lever moves to the manual mode gate from the automatic mode gate, the shift lever moves to the manual mode gate with keeping the gear of the shift range engaged and the clutch, which is connected with the shift range, disengaged.

10. The method according to claim 9, wherein when a shift range is selected by operating the shift lever in the manual mode, the gear of the selected shift range is engaged and the clutch is engaged with the engaged shift range, and when the shift lever moves to the neutral line from the selected shift range of the manual mode, the clutch is disengaged to be ready for selection of another shift range.
